(19) United States
(12) Patent Application Publication
(10) Pub. No.: US 2026/0149852 A1
(43) Pub. Date: May 28, 2026

(54) HIERARCHICAL LIVE COMMENTING WITH FOCUSED SUB-CHATS AND SHAREABLE PIVOTS

(71) Applicant: SynQ Inc., Los Angeles, CA (US)

(72) Inventors: Jesse Ugochukwu Ugwuegbu, Los Angeles, CA (US); Joshua Xavior-Paul Hicks, Modesto, CA (US); Reginald Jonathan Peacock II, San Francisco, CA (US)

(21) Appl. No.: 19/379,712

(22) Filed: Nov. 4, 2025

Related U.S. Application Data
(60) Provisional application No. 63/716,065, filed on Nov. 4, 2024.

(51) Int. Cl. H04N 21/4788; H04L 51/046; H04L 51/216; H04N 21/2187; H04N 21/43; H04N 21/81; H04N 21/858

(52) U.S. Cl. CPC H04N 21/4788; H04L 51/046; H04L 51/216; H04N 21/2187; H04N 21/43074; H04N 21/8113; H04N 21/858

(57) ABSTRACT

A hierarchical commenting framework for real-time interaction during live broadcast sessions is described. Comments and replies are stored in a parent-child structure forming a dynamic hierarchy maintained by a control server. A scoped viewing mode allows users to select a focus comment node to display only that branch while collapsing unrelated threads. Each sub-thread is accessible through a unique shareable link that scopes the interface to the referenced discussion. The system minimizes visual clutter and bandwidth consumption by transmitting updates only for active branches while maintaining live synchronization. This structure provides scalable, context-aware comment navigation for high-volume, multi-topic discussion environments.

### RELATED APPLICATION

This non-provisional application claims priority to U.S. Provisional Patent Appl. Ser. No. 63/716,065, filed on Nov. 4, 2024, entitled “INTEGRATED MUSIC STREAMING AND SOCIAL MEDIA APPLICATION WITH SYNCHRONOUS MULTI-USER LISTENING CAPABILITIES” by Jesse Ugwuegbu, et al., the contents of which being incorporated by reference herein in its entirety.

### TECHNICAL FIELD

The present disclosure pertains to the field of digital audio entertainment platforms, specifically focusing on an innovative music streaming application with integrated social features including hierarchical live commenting with focused sub-chats and shareable pivots.

### BACKGROUND

The evolution of computer and cellular phone compatible music streaming applications has marked a significant paradigm shift in the way people consume music, fundamentally transforming the music industry. These applications operate on the premise of granting users immediate access to an extensive library of songs through both computer and mobile devices. The underlying technical aspects of these platforms involve sophisticated audio codecs, such as Advanced Audio Coding (AAC) and Ogg Vorbis, for compressing music files without compromising quality. Streaming services often employ adaptive bitrate streaming (ABR) to dynamically adjust the bitrate based on users'internet speeds, ensuring a seamless listening experience. Content delivery networks (CDNs) are utilized to distribute music content globally, minimizing latency and optimizing speed. Digital rights management (DRM) technologies are implemented to safeguard intellectual property by controlling access and usage of copyrighted material.

The revolutionary impact of music streaming apps lies in their ability to provide unparalleled access, convenience, and personalization to users. The elimination of physical media and the shift away from individual song purchases have democratized access to an immense catalog of music. Algorithm-driven personalized playlists and recommendations cater to individual preferences, enhancing the overall listening experience. In essence, the advent of computer and cellular phone compatible music streaming applications has not only streamlined music consumption but has also redefined the ways in which individuals engage with and enjoy music on a global scale.

However, the current landscape of mainstream music streaming applications primarily focuses on providing individualized music experiences without placing a significant emphasis on connecting users socially, akin to the interactive nature of social media platforms. Unlike social media apps that facilitate direct interactions, comments, and sharing of content, traditional music streaming apps often lack features that foster real-time social connections among users and artists.

### SUMMARY

According to various embodiments herein, components of an illustrative integrated music streaming and social media application with synchronous multi-user listening capabilities are introduced. In particular, the present disclosure may illustratively be based on a novel approach to enhancing the social aspect of music streaming that involves the introduction of features that enable synchronous listening experiences, hereinafter referred to as “listening parties.” The application designed with this functionality may allow users in different locations to share and synchronize their music playback in real-time. This innovative feature may enable users to create virtual spaces where friends or communities can collectively listen to the same song or playlist simultaneously, fostering a shared auditory experience.

Specifically, the present disclosure introduces a hierarchical real-time commenting system that enables multi-level threaded discussions during live audio or video broadcast sessions (or otherwise). Each comment and reply is stored in a parent- child relational structure, forming a dynamic comment tree maintained by the control server.

The user interface allows participants to scope into a specific branch of the comment hierarchy, displaying only comments relevant to a selected topic while collapsing unrelated threads. Navigation controls permit seamless movement between hierarchical layers, enabling focused conversation within high-volume discussions.

Each thread or sub-thread can be addressed through a unique shareable link, allowing users to rejoin or share specific conversations directly. The architecture reduces communication clutter, lowers data transmission overhead by streaming only relevant comments, and enhances conversational clarity, particularly in live social environments.

Additional features of the present invention are discussed in the detailed description of the preferred embodiment below, and shown in the drawings hereof, and this summary is not meant to limit the scope of the embodiments herein.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example of a block diagram of a system architecture including multiple user devices, a control server, a streaming server, and supporting network and database components configured to enable synchronized broadcast sessions and social interactions;

FIG. 2 illustrates an example of a block diagram of a device that may be used with one or more implementations described herein, e.g., as any of the nodes or devices shown in FIG. 1;

FIG. 3 illustrates an example of a user interface for a media collaboration application in accordance with one or more embodiments of the present disclosure;

FIG. 4 illustrates an example of a flowchart showing the initiation and synchronization process of a live broadcast session, including creation of a streaming channel, listener joining, and real-time audio alignment;

FIG. 5 illustrates an example of a logic diagram showing dynamic broadcast control transfer mechanisms, including open-access, administrative, and voting-based control policies;

FIG. 6 illustrates an example of a hierarchical comment tree diagram showing parent-child relationships among comments and sub-comments within a live discussion thread; and

FIG. 7 illustrates an example of an application interface in scoped view mode, where only comments within a selected sub-thread are displayed and ancestor comments are compressed.

### DETAILED DESCRIPTION

The present disclosure may illustratively be considered in accordance with a media collaboration application (app), also referred to herein as the “SynQ” application, which can be implemented on a range of computing devices, including smartphones, tablets, laptops, and desktop computers, offering users a seamless, responsive experience across various platforms. On each device, the media collaboration app leverages the device's core components (e.g., a processor, memory, display, and audio system) to deliver high-quality audio playback, real-time interaction, and intuitive visual feedback. Mobile devices like smartphones and tablets are particularly suited for the social, on-the-go nature of the app, allowing users to tune into live listening sessions, vote, chat, and share music snippets anytime and anywhere. The app's interface adapts dynamically to different screen sizes and orientations, ensuring that each feature, from music streaming and playlist management to chat and polling, is easily accessible and visually engaging. For instance, on mobile devices, the app may use multi-touch gestures and quick-access menus, while on desktops and laptops, users might interact through mouse and keyboard inputs, all designed to maintain a unified experience regardless of the device.

The application harnesses the device's network connectivity and media broadcasting systems, whether through Wi-Fi or cellular data on mobile devices, to enable real-time interactions and content streaming. When streaming or “SynQing In/Out,” the app dynamically adjusts audio quality based on network conditions to ensure uninterrupted playback. Location-based features, such as proximity-based SynQ Spaces, leverage mobile devices'GPS capabilities to detect and connect users nearby. Additionally, smartphones and tablets can utilize near-field communication (NFC) for quick SynQ Space formation and QR codes for simplified joining, enabling quick connections in social or event-based settings. Each device's graphics processor and rendering capabilities ensure smooth visual transitions, such as the color changes in accordance with an engagement meter (e.g., “VibeCheQ” herein), and the display of user interactions within shared mediate spaces (e.g., “SynQ Spaces”), offering a visually rich and immersive experience.

Additionally, the media collaboration application operates within a distributed computer network and relies on a cloud-based server infrastructure to support its robust, real-time functionality. At the core, the media collaboration app employs a network of dedicated streaming servers that manage audio broadcasting and real-time synchronization across user devices. These servers handle the playback controls from users syncing out their playlists (e.g., “SynQers”), controlling music streams played for any number of listeners (e.g., “SynQees”), ensuring that commands like play, pause, or skip propagate instantly to all connected users within a SynQ Space. To manage high user traffic and enable scalable performance, the streaming servers may be load-balanced, distributing the audio streams evenly and dynamically adjusting based on demand to prevent latency or disruption during peak times.

A set of database servers manages user data, including profile information, playlists, comments, and play history. These servers may operate on a secure, redundant setup, ensuring data reliability and rapid retrieval of information for interactive features like hierarchical comments, music snippet posts, and performance tracking for leaderboards and badges. Additionally, these databases may store metadata for AI-driven components, enabling the app to suggest hashtags and adjust playlist options dynamically based on user engagement and preferences. For location-based features, the servers may integrate with geolocation APIs, or at least user-specified locations/tags, to identify and facilitate connections between nearby users, making it possible to synchronize audio streams for individuals within specific locations or events.

To support real-time interactions and minimize latency, the app's architecture may incorporate content delivery networks (CDNs) that cache frequently accessed media content, including popular audio snippets and artist spotlights. This setup ensures that users experience minimal delay in accessing high-demand content, even if they are located far from the primary data centers. The media collaboration app may also use dedicated notification and messaging servers that support the app's interactive features, enabling real-time updates for live commenting, polling, VibeCheQ ratings, etc. These servers may rely on WebSocket connections to push data instantly to devices, ensuring that users receive real-time updates without needing to refresh the app.

Security is a fundamental consideration within the media collaboration app's network architecture. The app may employ end-to-end encryption for audio streams and chat messages, ensuring user privacy and data integrity across the network. Servers may use secure access protocols and firewalls to guard against unauthorized access, with regular audits and updates to maintain compliance with data security standards. Together, this interconnected system of streaming, database, messaging, and CDN servers enables the media collaboration app to deliver a rich, immersive, and interactive music-sharing experience to users across a wide range of devices.

### System Architecture

The systems and methods described herein may be implemented within an integrated computing environment that includes user devices, one or more application servers, one or more streaming or broadcast servers, and a network infrastructure enabling real-time, low-latency communication among them. Together, these components provide the functionality necessary to support the interactive, synchronized, and socially enhanced music streaming experiences described in the present disclosures.

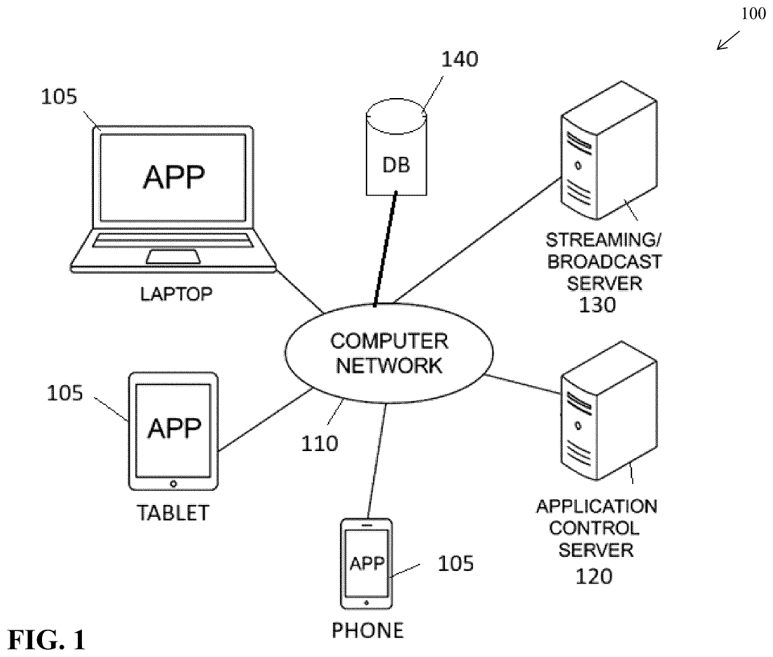

FIG. 1 depicts an example simplified architecture (computing system 100) of the synchronized social-streaming system herein. Multiple user devices (each a user device 105), such as smartphones, tablets, and laptops, connect through a communications network (computer network 110) to both an application control server 120 and a streaming/broadcast server 130 for the application. The streaming/broadcast server manages distribution of real-time audio content, while the control server handles session orchestration, playback synchronization, and social-interaction logic. Both servers may interface with a shared database (database 140) storing session data, playlists, analytics, and user profiles. Each user device executes an application (“APP”) that communicates bidirectionally with the servers, transmitting control inputs, playback states, and engagement events while receiving synchronized audio data and session updates. The network cloud (computer network 110) represents the broader communication infrastructure that enables low-latency coordination among participants, ensuring substantially simultaneous playback and shared social experiences.

As described herein, the user devices display an application interface that allows the user to start or join a broadcast session, view track information, and interact socially with other listeners. During operation, playback data is streamed directly from the streaming server, while the control server exchanges auxiliary information such as session identifiers, playback timestamps, and user actions (likes, comments, or control requests). Continuous data exchange may occur in both directions: audio streaming downstream and telemetry or engagement signals upstream. This arrangement separates time-critical media delivery from session logic, thereby improving responsiveness and synchronization accuracy across heterogeneous network conditions.

In particular, user devices provide real-time telemetry describing playback state, user inputs, and network latency. The control server aggregates this information to maintain session coherence, determine the currently active track, and broadcast control events to connected listeners. In parallel, the streaming server distributes encoded audio streams derived from the host playlist. Engagement and performance metrics collected at the control server are periodically stored in the database, where analytics modules compute aggregated measures such as listener count and participation rate.

Regarding the user devices 105, each user accesses the application through a computing device such as a smartphone, tablet, laptop, or desktop computer. The client-side application executes on the device's processor and leverages system resources including memory, display, audio subsystem, network interfaces, and optional positioning sensors. The application presents a graphical user interface through which the user can perform functions such as joining or initiating a shared streaming session (e.g., “SynQ session”), voting, commenting, generating hashtags, or sharing multimedia snippets. Mobile implementations employ touch input and gesture-based controls, while desktop implementations may use keyboard and mouse input, all with adaptive rendering that optimizes layout to screen size and orientation.

User devices 105 communicate with backend servers through wireless or wired networks using standard communication protocols (e.g., HTTPS, WebSocket, RTP, or WebRTC). The application dynamically adjusts streaming quality in response to available bandwidth to maintain a consistent user experience. Certain features, such as location-based discovery or proximity-based session joining, utilize device GPS, Wi-Fi triangulation, or NFC modules to identify nearby users and sessions. Other device sensors, such as accelerometers or microphones, may be optionally employed for additional interactive or analytical features. The client maintains a lightweight local cache for temporary song buffers, interaction logs, and session metadata, which are periodically synchronized with the backend servers.

The application control server 120 manages user authentication, session creation, access control, and synchronization of real-time events between users. It operates as the primary coordination point that tracks the state of each active SynQ Space, including the currently playing song, playback position, voting or comment activity, and participant list. The control server receives inputs from user devices (such as play/pause commands, votes, and comments), validates and timestamps them, and distributes authoritative state updates to all connected clients via push channels such as WebSocket or HTTP/2 streams. The same server also interfaces with persistent data stores for maintaining user profiles, playlists, chat histories, and analytics logs.

In some implementations, a separate streaming/broadcast server 130 is responsible for audio data delivery. As described in greater detail below, when a SynQer initiates a broadcast, the audio files selected by the user are uploaded or referenced through a “radio broadcast” microservice that generates a temporary streaming channel or URL corresponding to that session. Other users joining the session stream audio directly from this source, thereby hearing substantially the same content in real time. The broadcast server handles transcoding, buffering, and adaptive bitrate delivery to accommodate heterogeneous network conditions across devices. Multiple broadcast servers may be deployed behind a load balancer to ensure scalability and minimal latency, while an internal synchronization mechanism aligns playback timing across listeners with sub-second accuracy.

In alternative configurations, the streaming and application control functionalities may be co-located within a single physical or virtual server environment, depending on deployment scale and latency requirements. Both implementations support secure data exchange using encrypted channels.

Persistent storage may be maintained by database servers (database 140) that record structured data such as user credentials, playlists, comments, analytics logs, and SynQ session metadata. These databases may be replicated for redundancy and optimized for high-volume concurrent access. A messaging subsystem supports real-time chat, hierarchical comment threading, polling updates, and feedback events, all transmitted through publish-subscribe channels or message queues. For high-traffic media delivery, content delivery networks (CDNs) cache frequently accessed assets (such as popular songs, cover art, and trending snippet posts) closer to end users to minimize latency.

AI and analytics services may operate as auxiliary components connected to the control server, performing tasks such as mood classification, hashtag generation, or computation of engagement and influence metrics, as may be described in greater detail below. Geolocation APIs may also integrate with the servers to associate sessions with regions or venues, enabling discovery through “near-me” or event-specific listings.

Generally, all communication among system components may occur over a secure network employing standard Internet protocols. User data, audio streams, and messaging traffic may be encrypted end-to-end using TLS or equivalent cryptographic schemes. Firewalls, access control lists, and intrusion-detection mechanisms safeguard the infrastructure against unauthorized access. The architecture may employ microservices distributed across multiple cloud data centers for resilience and scalability, with load balancing and health monitoring to ensure continuous uptime. Together, the combination of user devices, control servers, streaming servers, and secure network pathways forms a cohesive platform capable of delivering synchronized, socially interactive audio streaming at scale.

From an implementation standpoint, the client application on each user device communicates with both an application control server and a broadcast streaming server, as described in the shared architecture. The control server manages user state, control delegation, and session metadata, while the streaming server delivers the live audio content. Control events such as song changes, voting outcomes, and queue updates are transmitted via WebSocket messages or similar real-time channels to ensure low-latency responsiveness. This architecture ensures that regardless of device or network variance, all listeners experience the same song content with synchronized transitions, and that any control transfers occur smoothly without interruption to playback.

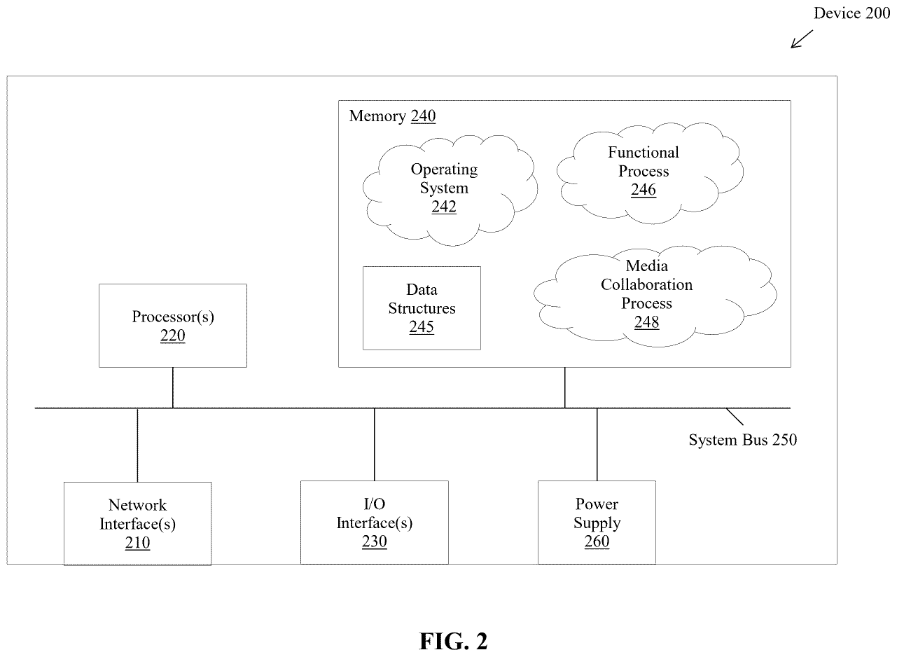

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may be configured as a conventional server computer, workstation, desktop computer, laptop, tablet, smartphone, or other computing device, and can be utilized to execute any of the software components presented herein

The device 200 may comprise one or more of the network interfaces 210 (e.g., wired, wireless, etc.), input/output interfaces (I/O interfaces 230, optionally inclusive of any associated peripheral devices such as displays, keyboards, cameras, microphones, speakers, etc.), at least one processor (e.g., processor(s) 220), and a memory 240 interconnected by a system bus 250, as well as a power supply 260 (e.g., battery, plug-in, etc.). Other components not specifically shown, such as a baseboard or “motherboard,” which is a printed circuit board to which a multitude of components or devices can be connected by way of the system bus or other electrical communication paths.

The network interfaces 210 include the mechanical, electrical, and signaling circuitry for communicating data over physical and/or wireless links coupled to the computing system 100. The network interfaces may be configured to transmit and/or receive data using a variety of different communication protocols. The network interfaces may be configured as a network interface card (NIC), such as a gigabit Ethernet adapter, wireless adapter, cellular adapter, optical adapter, or other circuitry capable of connecting the device to other computing devices over a corresponding communication link. It should be appreciated that multiple network interfaces may be present in the device, connecting the computer to other types of networks and remote computer systems.

The I/O interfaces 230 may be configured for receiving and processing input from a number of input devices, such as a keyboard, a mouse, a touchpad, a touch screen, an electronic stylus, a microphone, a camera, or other type of input device. Similarly, I/O interfaces 230 may also provide output, such as to a display, a computer monitor, a digital projector, a printer, a speaker, or other type of output device. Audio interfaces, in particular, may include the mechanical, electrical, and signaling circuitry for transmitting and/or receiving audio signals to and from the physical area in which a device 200 is located. For instance, audio interfaces may include one or more speakers and associated circuitry to generate and transmit soundwaves. Similarly, audio interfaces may include one or more microphones and associated circuitry to capture and process soundwaves. Video interfaces, in particular, may include the mechanical, electrical, and signaling circuitry for displaying and/or capturing video signals. For instance, video interfaces may include one or more display screens. At least one of the display screens may comprise a touch screen, such as a resistive touchscreen, a capacitive touchscreen, an optical touchscreen, or other form of touchscreen display, to allow a user to interact with device 200. In addition, video interfaces may include one or more cameras, allowing device 200 to capture video of a user for transmission to a remote device via network interfaces 210.

The memory 240 comprises a plurality of storage locations that are addressable by the processor(s) 220 and the network interfaces 210 for storing software programs and data structures associated with the implementations described herein. For example, the memory 240 may be a computer-readable storage medium such as a read-only memory (ROM) or non-volatile random access memory (NVRAM), or other suitable memory implementation. The device 200 may also (or alternatively) be connected to a storage device (internal or external) that provides non-volatile storage for the device. The storage device can store an operating system, programs, and data, which may be described in greater detail herein. The storage device can be connected to the device 200 through a storage controller, and may consist of one or more physical storage units. Still further, the device 200 may have access to other computer-readable storage media to store and retrieve information, such as program modules, data structures, or other data. It should be appreciated by those skilled in the art that computer-readable storage media is any available media that provides for the tangible, non-transitory storage of data and that can be accessed by the device 200. By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

The processor(s) 220 may comprise elements or logic adapted to execute the software programs and manipulate the data structures 245. In one illustrative configuration, the processor(s) 220 may comprise one or more central processing units (CPUs) which may operate in conjunction with one or more chipsets. The processor(s) 220 may be standard programmable processors that perform arithmetic and logical operations used for the operation of the device 200.

An operating system 242, portions of which are typically resident in memory 240 and executed by the processor(s), functionally organizes the node by, inter alia, invoking network operations in support of software processors and/or services executing on the device. These software processors and/or services may comprise one or more functional processes 246, and on certain devices, a “media collaboration” process (process 248), as described herein, each of which may alternatively be located within individual network interfaces.

According to one embodiment, the operating system may comprise the iOS® of Apple, Inc., the WINDOWS® operating system, the ANDROID® operating system, or other operating systems and/or variants.

Notably, one or more functional processes 246, when executed by processor(s) 220, cause each device 200 to perform the various functions corresponding to the particular device's purpose and general configuration. For example, a server would be configured to operate as a server, a smartphone would be configured to operate as a smartphone, a database would be configured to operate as a database, and so on. In various implementations, as detailed further below, one or more functional processes 246 and/or specifically the media collaboration process (process 248) may include computer executable instructions that, when executed by processor(s) 220, cause device 200 to perform the techniques described herein.

To do so, in some implementations, one or more functional processes 246 and/or process 248 may utilize machine learning (ML) and/or artificial intelligence (AI). In general, machine learning is concerned with the design and the development of techniques that take as input empirical data (such as network statistics and performance indicators) and recognize complex patterns in these data. Also, artificial intelligence is generally understood to be the simulation of human intelligence in machines, allowing them to perform tasks like learning, problem-solving, and decision-making. This is achieved through algorithms and systems that can perceive their environment, process data, and adapt their behavior to achieve goals, with examples including natural language processing and speech recognition. Forms of ML/AI may also include large language models (LLMs), which are a type of artificial intelligence (AI) that can understand, generate, and work with human language by being trained on vast amounts of text data. LLMs are used for a wide range of tasks, including answering questions, summarizing text, translating languages, writing content, and powering chatbots and virtual assistants. LLMs typically operate by predicting the next word in a sequence, similar to the autocomplete on a smartphone, but at a much more advanced level.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes. Also, it will be appreciated that the device 200 might not include all of the components as shown in FIG. 2, can include other components that are not explicitly shown in FIG. 2, or might utilize an architecture completely different than that shown in FIG. 2.

### Synchronous Social Audio With Dynamic Control Transfer

Traditional music streaming platforms allow users to listen individually or share playlists asynchronously, but they lack mechanisms for real-time communal listening where multiple users can experience the same track simultaneously while interacting socially. Although some services provide limited group sessions or collaborative playlists, these are generally confined to simple play synchronization or shared queue editing without a unified broadcast stream or structured control transfer among participants. There remains a need for a system that merges the immediacy of live broadcasting with the intimacy and interactivity of a small group, enabling users to share music in real time, engage socially, and manage control of the stream in fair, flexible ways.

Moreover, existing systems fail to offer mechanisms for dynamically transferring broadcast authority among participants in a session while maintaining audio continuity. Users are often constrained to a single host or chaotic free-for-all when multiple users attempt to control playback. There is also a lack of meaningful metrics and indicators of engagement during live sessions, such as a collective visualization of how “hot” or popular a broadcast is at any given moment. Furthermore, although location-based features are widely used for discovering nearby users or events, they have not been effectively integrated into shared streaming contexts to facilitate spontaneous participation in localized or thematic listening sessions. The disclosed system herein addresses these deficiencies by providing for synchronized social audio streaming that incorporates real-time broadcast control, dynamic participation models, and adaptive audience interaction feedback.

In one embodiment, the disclosed system allows a user, referred to as a “SynQer”, to initiate a live broadcast stream (referred to as a “SynQ Out”) that delivers synchronized audio playback to other users, referred to as “SynQees”, who join the broadcast session (e.g., “SynQ In”) through a “SynQ Space” or other connection mechanism. The broadcast is implemented through a streaming server that dynamically generates a temporary radio-like channel for each active SynQ Out. Audio files selected by the SynQer are streamed from the server to all connected SynQees via a common streaming URL, such that each listener hears substantially the same content in real time, subject only to minor network-induced delay variations. The SynQer may select songs from their personal playlists, the shared catalog, or a combination thereof, establishing the content and sequence of playback for the session.

In particular, music streaming apps today generally lack interactive, real-time music-sharing capabilities that offer a fully social, immersive experience. Although some platforms allow users to share playlists or synchronize listening with others, these features are often limited in terms of user control, interactivity, and personalization. The SynQing In/Out feature addresses this gap by enabling users (referred to as “SynQers”) to broadcast music to an audience in a “SynQ Space,” allowing others (the “SynQees”) to tune in and experience a synchronized audio stream in real-time. This innovative feature offers users a highly personalized and dynamic experience, where a single user can control music playback, interact with their audience, and even allow input from SynQees in creating a shared musical journey.

In the SynQing In/Out feature, users gain a new level of control over their broadcasting audience. Unlike traditional streaming platforms that function on a subscriber model, SynQing In/Out allows users to toggle broadcasting visibility between a public audience, followers, friends, or even specific individuals. This selective control over who can join a particular broadcast is central to creating intimate, curated listening spaces that can flexibly serve different community or social circles.

In a SynQ Space, SynQers can manage the playback experience by queuing up songs from their own music library or the broader SynQ catalog, giving them the flexibility to tailor the session to their audience's preferences. They can choose to queue songs sequentially or opt to play specific songs immediately, creating a real-time, personalized playlist. In one embodiment, beyond mere queueing of song lists, the techniques herein offer a unique “SynQronization” feature, when a SynQer presses play, pauses, or skips a track, all SynQees experience the action simultaneously, creating a synchronized audio experience that mimics a shared listening environment, as if all users were plugged into the same device.

The feature further supports offline listening, where SynQees can download songs from a SynQ playlist for offline access. This capability allows users to enjoy a curated playlist experience without needing an internet connection, ensuring that the SynQ Space can be enjoyed anywhere, anytime.

Adding a layer of interactivity, SynQees can “pause” their SynQ In session by muting the shared audio stream while allowing the song to continue for other users. When ready, they can rejoin the audio seamlessly, a feature that adds a personalized touch to the real-time listening experience without interrupting the session for others. That is, the system also incorporates an Individual Pause capability, allowing any SynQee to pause playback locally without affecting the global broadcast timeline. When the user resumes, the playback re-synchronizes with the live stream at the current broadcast position, maintaining temporal continuity with the active session rather than resuming from the paused point. This ensures that the shared experience remains cohesive for all participants while still allowing individual flexibility.

Further customization options add unique capabilities, like EQ Copy, which enables SynQees to match their audio equalizer settings to the SynQer's preferences, including headphone profiles where applicable. Another tool, Song Snipping, lets users trim and edit song segments within playlists, providing DJ-style control over playback and adding a new dimension of creativity to the listening experience.

The overall structure and user experience for this feature can be visualized in the following flow: a SynQer initiates a broadcast, selects an audience from options like Public, Friends, or specific individuals, and queues or plays songs. SynQees then join, and while they follow the SynQer's controls (e.g., play, pause, or skip), they also retain certain customization options, such as pause/mute and EQ Copy. The session concludes with a summary of SynQ Minutes, leaderboards, and performance-based badges.

Advantageously, the SynQing In/Out feature brings an entirely new level of interactivity to music streaming, transforming passive listening into an active, social experience. By allowing users to engage with both the broadcaster and other listeners, the feature makes streaming feel like a community activity. According to one or more embodiments herein, the this music-sharing method enables a first user, known as the SynQer, or a set of SynQers, to broadcast audio content to one or more users, referred to as SynQees, within a designated SynQ Space, according to a curated set list (queue of songs/media). Through this feature, the SynQer(s) can control the audio experience in real-time, with all actions executed by the SynQer (s)(such as play, pause, or skip) reflected simultaneously across all SynQees'audio streams. Also, the audience-selection mechanism within SynQing In/Out provides the SynQer with the ability to toggle between different broadcasting settings (e.g., public, followers, friends, or specific users) adding a unique layer of selectivity and control over who may receive the broadcast.

In various embodiments, the invention provides a novel interactive environment referred to as a “SynQ Space.” A SynQ Space represents a dynamic, persistent digital room that unifies social interaction, media control, and synchronized streaming functionality within a single collaborative interface. Each SynQ Space is hosted and managed by a control server that coordinates playback synchronization, membership permissions, and message flow among user devices. The corresponding streaming server delivers the synchronized audio stream, while the control server handles event state, chat messages, engagement metrics, and broadcast authority transitions. Together, these components establish a social broadcasting ecosystem that bridges conventional messaging systems and real-time audio control frameworks.

The SynQ Space interface allows users to discover, create, and participate in broadcast-enabled chat rooms where media playback and conversation occur concurrently. Upon entering the SynQ Space view, users are presented with a list of available rooms that they have joined or that are publicly accessible based on their user plan or permissions. Each entry in the list includes identifiers such as the space name, most recent message preview, participant count, and connection indicators, enabling participants to identify active or trending spaces. A refresh command triggers real-time updates from the control server to ensure the displayed room states reflect current engagement activity. Selecting a space entry transitions the user into an active chat and playback session, where messages, playback events, and controls are streamed in real time.

Within an active SynQ Space, the interface enables the seamless coexistence of music streaming and social discussion. The chat component supports layered conversation structures, displaying participant profile images, timestamps, and real-time status indicators synchronized through the control server. A “sync indicator” visually represents whether live playback synchronization is active, allowing users to identify when the host or another participant is broadcasting. During synchronized sessions, user devices receive real-time playback state updates that align their audio with the broadcast controller's timeline within a bounded synchronization threshold, ensuring consistent playback across devices regardless of network variations.

The system further introduces inventive methods for creating and managing SynQ Spaces. A user can initiate a new space using an integrated control pane accessible from the primary interface. The creation workflow allows configuration of key metadata including group name, description, image, and join permissions. For example, a user can enable or disable a “scan-to-join” option, which automatically generates a machine-readable QR code tied to a unique session identifier within the control server's registry. When another user scans the code using their device, the application verifies space availability and authentication tokens, and upon validation, seamlessly adds that user to the appropriate SynQ Space. This mechanism enables real-world onboarding of new members without requiring manual invitation links, expanding the notion of spontaneous, location-anchored digital gathering.

Once a SynQ Space is created, the host can invite participants by searching among friends or followers or by scanning QR codes associated with other spaces. The interface displays each contact's image and status to facilitate quick selection. The control server validates invitation limits based on the user's subscription tier and displays contextual messages if creation or membership thresholds are reached. Before finalizing, a preview screen provides an opportunity to review space parameters and member lists, ensuring that all configuration options (e.g., access level, visibility, and synchronization permissions) are confirmed before activation.

A distinctive aspect of the SynQ Space system is its integration of SynQ In and SynQ Out functionalities. SynQ Out allows a user to act as a broadcaster, selecting audio tracks or playlists and transmitting them in real time to designated recipients, including individual users, friend groups, or public audiences. Listeners participating via SynQ In join these sessions as synchronized recipients, hearing the same song sequence with tightly aligned playback. Unlike conventional streaming platforms that provide only independent listening experiences, this synchronized broadcast paradigm enables shared music sessions controlled by user-defined rules.

The system herein further includes intelligent audience targeting and control granularity. Before initiating a broadcast, a user selects the intended visibility scope, such as “Public,” “Friends,” or “Followers”, and may associate one or more hashtags to contextualize the broadcast theme or mood. These hashtags become searchable indices across the platform, allowing other users to discover live or recorded sessions based on shared interests. During playback, the broadcaster retains control of the media queue, but control can be dynamically passed to another participant based on system policies (e.g., administrator assignment, open queue, or voting-based delegation).

Within the SynQ Out player interface, the broadcaster can view metadata such as song title, artist, playback duration, and listener engagement metrics. Listeners can interact socially by reacting to songs, adding comments, or tagging other users and songs using symbolic prefixes (“@” for mentions, “#” for tags, and “*” for songs). These symbolic mentions are parsed by the application and linked to relevant entities in the underlying database, enhancing the interconnectivity of social interactions and media content.

The system also supports shareable broadcast links generated through a dynamic linking service. When a broadcaster shares a SynQ Out session, the system produces a persistent URL or QR code embedded with metadata describing the current broadcast state. Recipients of the link are directed into the appropriate SynQ Space and automatically aligned with the broadcast stream, reducing friction in discovery and participation.

Together, these mechanisms establish an inventive framework for synchronized, socialized streaming control. Unlike conventional chat or media applications that operate independently, SynQ Spaces create an integrated environment where community, control, and content coexist. The convergence of synchronized media, multi-user control logic, dynamic onboarding, and semantic tagging represents a technical advancement that transforms passive music consumption into an interactive and participatory broadcast ecosystem.

According to one or more embodiments of the present disclosure, the system supports several operational modes that govern control of the broadcast stream. In particular, the experience of sharing music in social settings often involves passing control from one person to another, with each individual curating the playlist for a time before handing it off. Traditional music streaming platforms, however, lack this dynamic control transfer, often limiting the session to a single host or allowing chaotic, unstructured access for all listeners. This restriction can prevent a truly social and collaborative listening experience. The “Pass the Aux” feature in SynQ Spaces introduces a new approach, enabling structured, temporary control transfers within a broadcast, allowing users to take turns and contribute actively to the listening session.

The Pass the Aux feature empowers users to share control within a SynQ Space by letting the SynQer transfer music broadcasting capabilities to another user. This functionality creates a smooth handoff of music playback rights, enabling users to take turns selecting and playing songs for everyone in the session. Unlike conventional platforms where either one person controls the session or everyone has equal access (which can lead to disorganized playback), Pass the Aux provides a structured transfer process, where control remains with one designated individual at a time.

In “Open Aux Mode”, any user in the SynQ Space can contribute tracks to the broadcast queue from their own playlists. The system may maintain a first-come-first-served queue, or, preferably, a round-robin order in which songs are drawn sequentially from each active participant's queue. For example, if users A, B, and C are connected, playback may proceed by alternately selecting one song from each user's list (A1, B1, C1, A2, B2, C2, and so on). If a participant's queue becomes empty, the system skips to the next user automatically, ensuring uninterrupted playback. As participants join or leave the SynQ Space, the round-robin sequence dynamically reconfigures in real time.

In “Admin Aux Mode”, an authorized user (typically the creator or designated administrator of the SynQ Space) maintains exclusive control over broadcast permissions. The administrator may manually select which users are permitted to contribute songs, temporarily assign or revoke control, and determine the ordering logic among contributors. This mode provides a more curated experience suitable for structured events or live shows where control must remain consistent.

In “demAUXracy Mode”, or more simply, “Democracy Mode”, control of the broadcast is determined through audience voting. When one or more users request to take the “aux,” the system initiates a timed voting window during which all listeners may cast votes to select the next controller. For instance, three users may submit requests within a two-minute interval, followed by a one-minute vote collection phase. The user receiving the majority vote is granted broadcast control for the next designated period or until another voting cycle occurs. The system may include tie-breaking logic, such as prioritizing earlier requestors or those who have not recently held control, to maintain fairness and engagement. Additional rules may be configured, such as requiring that a requestor must have participated in the session for a minimum number of songs before being eligible to request control, thereby preventing transient or malicious participation.

Hybrid modes may also exist, such as demAUXracy Mode resulting in a plurality of aux controllers, which may then be managed in a round robin style similar to Open Aux, just with the limited number of controllers. As another example, an Admin Mode administrator may put the next controller(s) up to a vote of the listeners.

To request control, generally in embodiments other than Open Aux (unless restricted to a set number of users), a user within the SynQ Space can ask to “take the Aux,” at which point the SynQer can activate a poll that prompts the audience to vote on whether to grant the requester control, or to compete against other users for control that have also requested the Aux. If the poll yields a “win” (e.g., a majority) in favor of approval, the user requesting the Aux gains control, allowing them to broadcast their selected tracks to the entire group (in real-time or by controlling the upcoming song queue, accordingly). This feature mimics the social experience of passing an Aux cord among friends, introducing a natural, real-world dynamic into the digital space and fostering an environment of shared discovery and collaboration.

The structured transfer is managed in real time, ensuring seamless transitions between users without disrupting the playback experience for the listeners. For instance, when control shifts from one user to another, the song currently playing will continue uninterrupted until the new Aux-holder selects the next track. Additionally, users can request control again after a designated time limit or based on specific session rules, preventing any single user from monopolizing the session and encouraging fair participation.

Through Pass the Aux, the feature also facilitates diverse musical contributions within the same session, allowing users to explore multiple genres, styles, or moods in a single stream. This dynamic enhances the social experience and allows SynQees to feel more involved in the broadcast, as they contribute directly to the shared listening experience. Overall, the Pass the Aux feature elevates the digital music-sharing experience by creating an atmosphere that closely resembles in-person social interactions, with each user having the opportunity to shape the playlist collaboratively.

Advantageously, the Pass the Aux feature creates an authentic social experience by allowing users to take turns controlling the music in a structured, organized manner, which mirrors the real-world practice of passing an Aux cord. By introducing a voting process, it ensures that the listening experience remains cohesive and enjoyable, with control transfers happening only with audience approval. This feature brings a collaborative, community-oriented element to SynQ, enabling users to experience diverse musical selections while retaining control over the session's flow. The structured handoff and timed request options prevent any one user from dominating the session, fostering a fair, inclusive environment that enhances engagement and social interaction. Through Pass the Aux, SynQ bridges digital streaming with real-world social dynamics, creating a unique, memorable experience for all participants.

According to one or more embodiments of the present disclosure, the system also supports an integrated “VibeCheQ” subsystem that monitors audience interaction to generate visual indicators of engagement and enjoyment. The system aggregates inputs such as likes, emojis, comment frequency, and other real-time interactions, computing a composite engagement score that reflects the collective energy of the session. The broadcast interface may visually change in response to the VibeCheQ level, such as, for example, intensifying color saturation or displaying animated icons to indicate high energy or popularity, or adding certain sessions to recommended lists for listeners to join. Sessions exhibiting strong engagement may be highlighted within discovery lists as “hot SynQs,” encouraging new users to join. Conversely, sessions with low activity may appear desaturated or lower in ranking, providing an organic feedback loop that visually communicates session dynamics.

In particular, music streaming platforms primarily provide passive interactions, offering limited ways for listeners to give real-time feedback on a session's quality. While simple “like” or “dislike” features exist, they fall short of capturing ongoing audience sentiment and engagement during a live music stream. The VibeCheQ feature in SynQ Spaces addresses this gap by allowing users to continuously rate the quality of a SynQ Out session, creating a dynamic and visually engaging experience that reflects the collective mood. This feature provides instant feedback to the SynQer and allows SynQees to influence the session's atmosphere, fostering a more responsive and interactive environment where the mood is shaped by audience reactions.

VibeCheQ introduces a gamified element to the SynQ Space by allowing SynQees to vote on the session's quality. Users can upvote or downvote based on consecutive good or poor songs, influencing the screen's saturation and visual aesthetics. This feature provides immediate feedback to the SynQer, creating a responsive and interactive environment. Vibe CheQ enhances user engagement and satisfaction by encouraging positive song selections and dynamic playlists. It sets the app apart by incorporating real-time audience reactions, making the music streaming experience more visually and emotionally engaging.

That is, the VibeCheQ feature introduces a real-time rating system where SynQees can upvote or downvote the vibe of a SynQ Out session based on the current song or the overall playlist. As listeners cast their votes, the cumulative ratings are reflected through visual changes on the SynQer's screen, providing immediate feedback on how the session is resonating with the audience. For example, if consecutive songs receive high ratings, the screen's colors may become more saturated, with vibrant purples and blues symbolizing an energized, positive vibe. Conversely, a series of downvotes may cause the colors to fade into black-and-white or muted tones, indicating a low-energy session or a disconnect with the audience's preferences.

In addition to simple up/down-votes, the techniques herein may also utilize other factors in the VibeCheQ, such as number or rate of comments, number or rate of joins of SynQees, number of shares, or any other measurable or assumed level of engagement of the listeners. For instance, in one embodiment, the techniques herein may use AI to interpret actual conversations within a SynQ Space (chats, shares, etc.) to take valuable insight to what people are saying about the session and/or songs, like understanding the positive feelings of “this space is hype!” or “fire fire fire!” versus the negativity implied with comments such as “this song is totally wrong for this space” or “ugh, killing the vibe! Boo!” (or, simply, the rate of positive comments, or any comments at all, slowing down considerably, etc.).

This continuous feedback system gives the SynQer valuable insights into what resonates with their listeners, allowing them to adjust the playlist to improve audience engagement. The Vibe CheQ feature also tracks engagement through comments, likes, and interactions, considering these metrics in the vibe calculation. As activity in the SynQ Space increases, the session's vibe visual intensifies, showing that the broadcast is gaining momentum and that the audience is actively engaged.

In addition to immediate visual cues, VibeCheQ can also influence the session ranking within SynQ Spaces. Sessions with consistently high vibes are promoted within the app, appearing as popular SynQ Outs that other users might want to join. This gamified approach encourages SynQers to select crowd-pleasing songs and craft dynamic playlists that maintain a high energy level, as they are rewarded with increased visibility and potential new listeners.

By updating the vibe rating with each new song, VibeCheQ moves beyond the static “like” model found in traditional social media and streaming apps. This ongoing rating feature captures real-time audience sentiment, allowing users to influence the mood of the session actively and create a collaborative listening experience. The feature ultimately transforms passive listening into an interactive event where both the SynQer and SynQees contribute to the session's atmosphere and energy.

Advantageously, the VibeCheQ feature enhances interactivity by allowing SynQees to actively shape the atmosphere of a live session, moving beyond simple “like” functions to create an immersive, mood-responsive experience. By providing real-time visual feedback, Vibe CheQ allows the SynQer to understand audience sentiment and adjust the session accordingly, fostering a stronger connection with listeners. The engagement-driven vibe calculations and session ranking offer a gamified experience that incentivizes high-quality, crowd-pleasing playlists, rewarding SynQers with increased visibility and popularity within the app. Through this feature, SynQ transforms passive listening into a dynamic, collaborative experience where audience feedback drives the mood and energy, enhancing both user engagement and enjoyment.

According to one or more additional embodiments of the present disclosure, the system also supports location-awareness to further enhance user discovery and participation. The application allows users to browse or filter active broadcasts by proximity, using geolocation tags associated with each SynQ Out, or based on physical proximity detection. A user entering a venue such as a gym, park, or campus may view nearby live sessions and join immediately. The system may also allow hosts to tag their sessions with general locations or events, enabling collective listening experiences tied to local communities or occasions (e.g., selecting such location tags as “Boston” versus “Los Angeles” or “OSU Tailgate” versus “StrongArm Gym San Francisco” or “Newport Cool-Coffee-Café”). This contextual linkage transforms passive streaming into a location-anchored social experience.

That is, Location SynQ is a feature that allows users to synchronize their SynQ experience with others based on selected locations (whether the user is within that location or simply wants to join a session that is sourced from a specific location), or that are specifically within a certain distance. This feature adds a geospatial element to the app, enabling users to connect with nearby (or locale-based) individuals who share similar music preferences. It transforms the music streaming experience into a social and local event, fostering connections between users based on their physical proximity. This unique feature goes beyond the typical global reach of music streaming apps, creating a more localized and community-driven platform.

While music streaming is typically a remote and solitary experience, many social experiences are enhanced by proximity-based interactions, where people share moments in real-time and physical space. Current streaming platforms lack the ability to connect users based on geographic location or proximity, missing an opportunity to foster real-world interactions through music. The Location/Proximity-Based SynQ feature bridges this gap by allowing users to connect with others in nearby locations, creating a music experience that transcends the digital realm and enhances social engagement in physical spaces. This feature is designed to foster real-world connections among users who share similar music preferences, transforming streaming into a shared experience within specific venues, events, or social settings.

The Location/Proximity-Based SynQ feature empowers users to SynQ In/Out with others within a specified distance or within a tagged location, creating a spatial element to music discovery and interaction. For instance, users walking into a gym, café, or park can join a nearby SynQ Space, synchronizing their music experience with others in the area. This capability allows for shared music experiences based on geographic proximity, enhancing the sense of community and creating spontaneous connections through music. The feature not only supports casual music sharing but also provides opportunities for users to engage with local culture and discover music in a way that reflects their environment.

One unique implementation of this feature is a SynQ Live Concert, where users at events can connect to a silent disco-style experience, tuning into multiple SynQers broadcasting to a private group. This setup enables attendees to listen to live feeds from various DJs or performers within the same venue, offering a personalized experience within a shared environment. Whether users prefer an upbeat set or a chill mix, they can easily switch between broadcasts, catering their music experience to their preferences while remaining part of the communal event.

The feature also includes NFC-based SynQ Spaces, where users can tap their phones together to create a shared SynQ session. Imagine students in a library or friends at a silent disco who want to sync their music; with NFC, they can create an exclusive SynQ Space just for their group. Users also have the option to join via QR codes, adding flexibility for quickly forming SynQ Spaces that connect users within the same vicinity. This technology enables groups to come together spontaneously, adding a digital layer to real-world interactions and allowing for a unique blend of music sharing and social engagement.

With Location/Proximity-Based SynQ, users gain the ability to explore SynQ Spaces that reflect their immediate surroundings (or chosen locations from afar), promoting a sense of presence and encouraging connections with people in close proximity. By merging digital streaming with physical spaces, this feature turns any location into a potential music-sharing hub, making music streaming a more social, place-based experience.

Advantageously, the Location/Proximity-Based SynQ feature enhances the social element of music streaming by allowing users to synchronize their music experience with others in their immediate vicinity or within a particular location as desired. This proximity-based (or location-based) approach transforms digital streaming into a shared, interactive experience rooted in real-world environments. By blending digital and physical music-sharing, this feature enriches user engagement, making music streaming more adaptable, interactive, and grounded in the real world.

Other features may also be included within the innovative synchronous audio social platform. For instance, in social media, users often communicate with multimedia elements like images, videos, and GIFs to express thoughts or reactions. However, traditional music streaming platforms typically limit user interactions to static playlists or text-based comments, missing an opportunity to blend audio with visual elements that enrich expression. A “Music Snippet Post with Comment/GIF” feature in SynQ Spaces allows users to create short audio clips from songs and share them with text, images, videos, or GIFs, introducing a new, expressive way to interact with music on a social platform. This feature merges music with multimedia, offering users a creative outlet to share snippets of songs in ways that capture mood, personality, and context more vividly. The Music Snippet Post with Comment/GIF feature empowers users to extract short clips, or snippets, from songs and post them directly within their SynQ Space. Rather than sharing entire songs or playlists, users can select key moments or favorite parts of a track (such as a catchy chorus or memorable lyric) and pair these snippets with a personal message, image, video, or GIF. This combination transforms music sharing into a multimedia storytelling experience, where each snippet reflects not only the user's musical taste but also a visual or textual narrative that adds context and emotion to the clip.

To create a snippet post, users can open the audio player, select a specific segment of a song, and then add a comment or multimedia element. For example, a user might capture a 15-second snippet of an upbeat song and pair it with a GIF of friends dancing, conveying a lively mood that invites others to engage or react. This feature allows users to communicate their emotions or experiences in a way that resonates more deeply with listeners, making the music-sharing experience more personal and relatable. The snippets can be shared on timelines, profiles, or within group chats, creating a dynamic feed where users discover new songs or see favorite tracks presented in fresh, unique ways. This snippet-based sharing format aligns well with modern social media consumption, where users often prefer shorter, engaging content that they can quickly explore and react to. Additionally, snippets with high engagement may gain visibility on popular feeds within the SynQ app, encouraging users to craft creative, high-quality posts that resonate with the community.

By integrating audio snippets with multimedia comments, the feature also provides artists and creators a platform to showcase their music in bite-sized, interactive posts. Fans can take favorite parts of a song, pair them with a GIF or reaction, and share them widely, generating buzz around the track. This format not only promotes discoverability but also adds a layer of personalization and creativity to music sharing that amplifies the artist's reach within the social community.

Another additional feature according to one of more embodiments herein may be a “Polling” feature adds an interactive element to the SynQ Space, allowing the SynQer to engage with the audience in real-time. Users can vote on various issues, including Next Song Suggestions, Pass the Aux recipients, or conversation starters. This feature empowers the audience, providing them with a voice in shaping the SynQ experience. By incorporating polling, the app transcends the traditional one-way streaming model, turning it into a collaborative and participatory platform that adapts to the preferences of the community.

In traditional music streaming platforms, the user experience is largely passive, with minimal opportunities for interaction or feedback during live broadcasts. While listeners may be able to like songs or leave comments, they typically have no say in shaping the direction of the music stream itself. This lack of interactivity can lead to a one-dimensional experience that limits user engagement. The Polling feature in SynQ Spaces addresses this gap by giving listeners an active role in influencing the content of a SynQ session. By integrating polling functionality directly into the music-streaming experience, SynQ enables users to participate in real-time decisions, such as voting on the next song or selecting conversation topics, creating a collaborative and adaptive listening environment.

The Polling feature introduces a layer of interactivity to the SynQ experience, empowering SynQees to influence what happens next within a SynQ Space. With this feature, a SynQer can activate polls during a live session, allowing participants to vote on options such as the next song to be played, or even who should take control of the “Aux,” thereby curating the experience according to group preferences. For instance, during a session, the SynQer may open a poll for “Next Song Suggestion,” enabling the audience to vote from a list of choices or make specific song requests. As users cast their votes, the SynQer can make real-time adjustments to the playlist, ensuring that the music reflects the mood and interests of the listeners.

Additionally, the Pass the Aux feature can integrate with polling, where users can request control of the broadcast, and a poll will open for the audience to vote on whether the requesting user should be granted the Aux. If over 50% of participants agree, the user gains temporary control, allowing them to select and play songs for everyone in the SynQ Space. This feature mimics the social experience of a group gathering, where friends share and take turns controlling the music, adding a dynamic social component to the digital listening experience.

SynQ Polling also supports more complex audience insights through AI-driven interpretation of user preferences. For example, if the audience votes consistently for high-energy songs, the AI could detect this trend and adjust the suggested options to better match the group's mood, such as offering only upbeat or genre-specific choices. This AI-driven functionality ensures that the session remains responsive to the audience's evolving preferences, delivering a curated yet adaptive experience.

The Polling feature further extends to Voting Ads, which present interactive advertisements within the timeline. These ads can be configured to collect audience feedback through voting, providing advertisers with valuable data about user preferences and enhancing engagement by inviting users to interact directly with the brand. This aspect not only benefits advertisers but also keeps the user experience interactive and engaging, even during ad breaks.

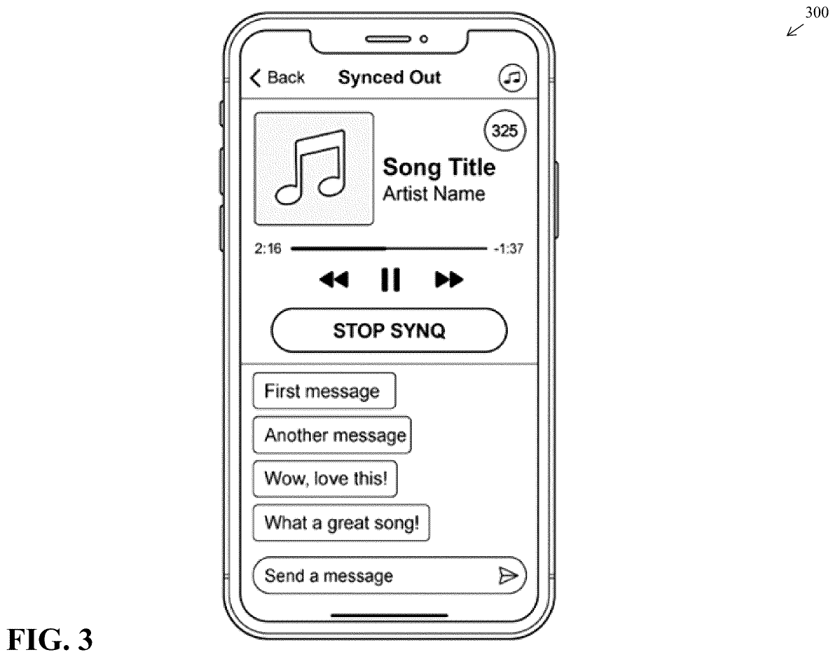

FIG. 3 illustrates an example user interface (user interface 300) for an embodiment of the inventive social synchronization and media control system. As shown, the interface is rendered on a user device such as a smartphone or tablet, and provides an integrated view for synchronized playback, messaging, and session control within a SynQ broadcast or shared listening experience.

The display includes a playback region at the top, which presents metadata associated with the currently playing song. This metadata includes a graphical song representation or artwork thumbnail, a song title, and an artist name. A playback progress indicator is positioned below the metadata and dynamically reflects the elapsed and remaining time for the track, enabling visual feedback of the synchronized playback state across connected devices. Playback control icons are provided adjacent to the progress bar, allowing authorized users to initiate play, pause, skip, or reverse commands within the shared session.

A SynQ control element, currently labeled “STOP SYNQ,” is prominently positioned below the playback controls. This element enables a broadcasting user to terminate or pause the synchronization of playback across one or more remote devices participating in the active SynQ session. The button may also signal the control server to broadcast a state update to all listening clients, ensuring that their playback streams are simultaneously halted or transitioned into a waiting state to maintain temporal alignment.

Beneath the playback section, a real-time messaging panel is displayed, showing chat messages exchanged among participants in the active SynQ session. Each message may be rendered within a discrete bubble element, maintaining chronological order from top to bottom. This layout enables conversational interaction that complements the shared media experience. Messages may include comments, reactions, or symbolic tags (e.g., “@user,” “#tag,” or “*song”) that are parsed by the system for association with corresponding entities in the tagging and search index described elsewhere in this disclosure.

A text input field labeled “Send a message” is positioned at the bottom of the interface, allowing users to compose and transmit new messages to the group in real time. Messages entered through this input are communicated to the control server, which propagates them to other participants via synchronized messaging streams. The interface may include an adjacent send icon, which, when activated, transmits the user's input to all active session members and updates the conversation feed.

Collectively, the interface illustrated in FIG. 3 demonstrates at a high-level how the app herein merges synchronized media control with real-time social interaction within a single unified display. Unlike traditional streaming players that isolate playback from communication, this interface establishes a bidirectional link between playback events and social messaging activity. Through this integration, users experience a shared auditory environment enriched by live conversation, fostering connection and engagement synchronized to the rhythm of the music itself. Notably, while a certain configuration of the user interface 300 is shown, other suitable configurations may be used with the inventive app herein, and the view shown is merely one example display for the purpose of discussion herein.

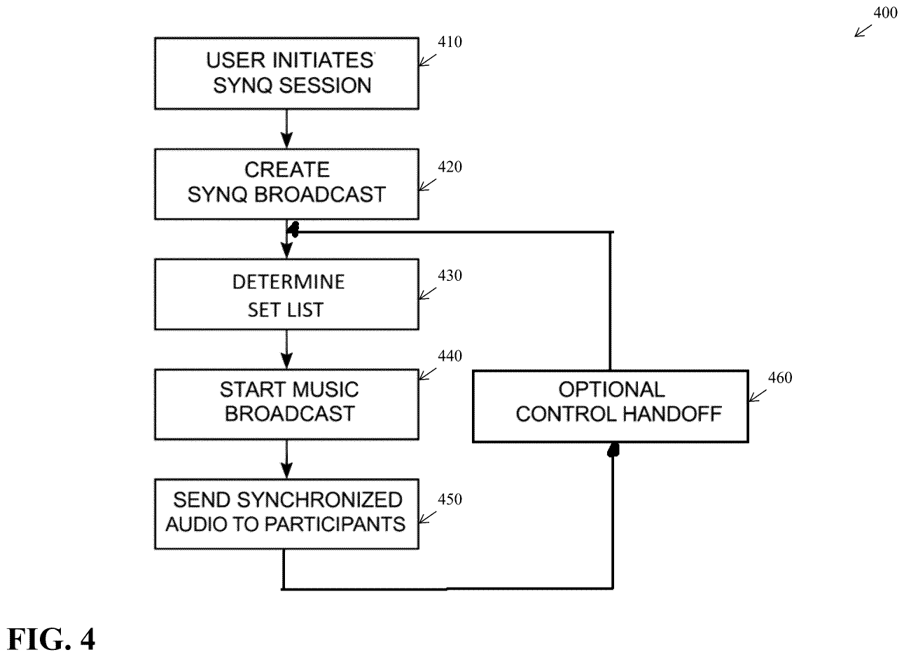

FIG. 4 shows a representative flow of operations 400 for initiating and synchronizing a broadcast session. The process begins in step 410 when a user selects a “Sync Out” command within the application (“user initiates a SynQ session”), prompting the control server in step 420 to create a unique streaming channel and corresponding metadata entry (“create SynQ Broadcast”). The host's selected track list may then be uploaded (all at once, over time, etc.) or referenced by the streaming server in step 430 (“determine set list”), which begins distribution of the first song in step 440 (“start music broadcast”), with the synchronized audio sent to (i.e., received by) select participants in step 450 (“send synchronized audio to participants”). Note that while the session continues, the set list may be extended/updated, and as shown in step 460, control of the set list may be changed to other authorized users as described herein (“optional control handoff”). The flow concludes whenever playback the session ends, ensuring clean termination of the broadcast and archival of listening metrics.

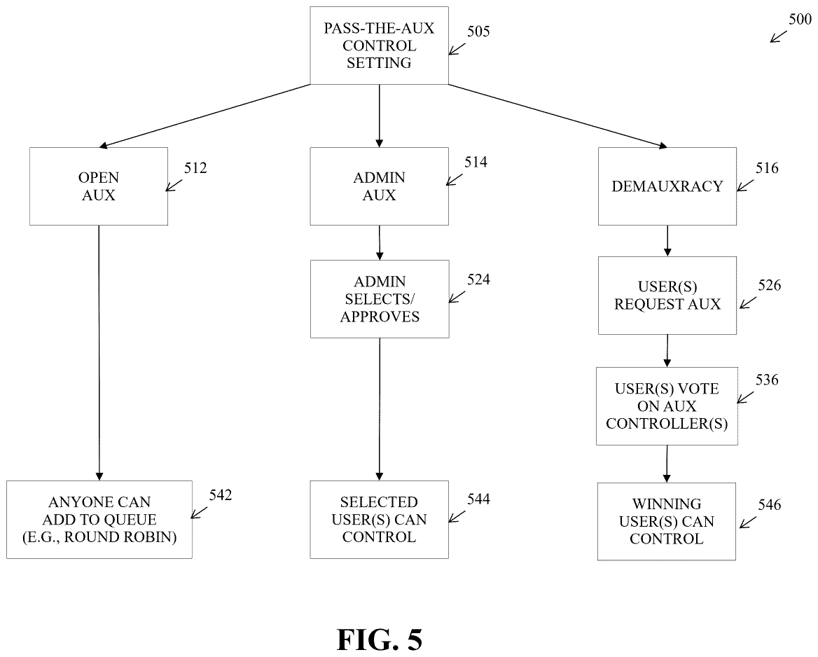

FIG. 5 illustrates logic 500 governing transfer of playback authority among participants. Three operational modes are shown: Open Aux, Admin Aux, and demAUXracy. As shown, a Pass-the-Aux control setting 505 may determine whether the control is Open Aux 512, Admin Aux 514, or demAUXracy 516. In Open Aux mode, the control server automatically cycles track selection among participants in a round-robin queue based on each user's playlist, i.e., anyone can add to the queue (control logic 542). Admin Aux mode enables a designated administrator to assign or revoke control manually (“admin selects/approves” 524), limiting additions to approved users that can control (control logic 544, selected user(s) can control). The demAUXracy mode introduces a voting mechanism where participants request control (block 526) and peers vote (block 536) to determine the next controller(s) (control logic 546, winning user(s) can control). The diagram highlights how these modes share a common decision framework yet differ in how authority transitions occur, allowing adaptable control dynamics across social contexts. Note that the setting for which mode is in use (Pass-the-Aux control setting 505) can change mid-session, and hybrid modes may also be configured (not explicitly shown for clarity).

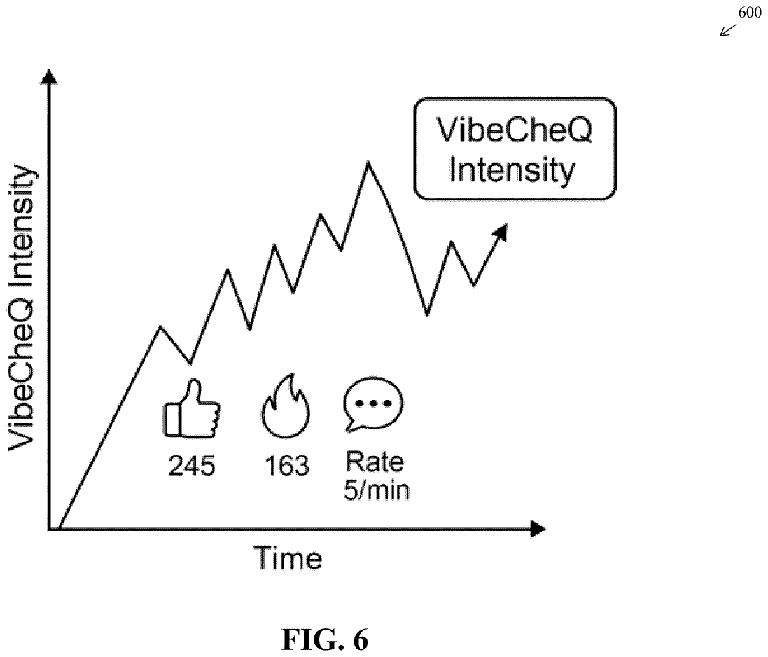

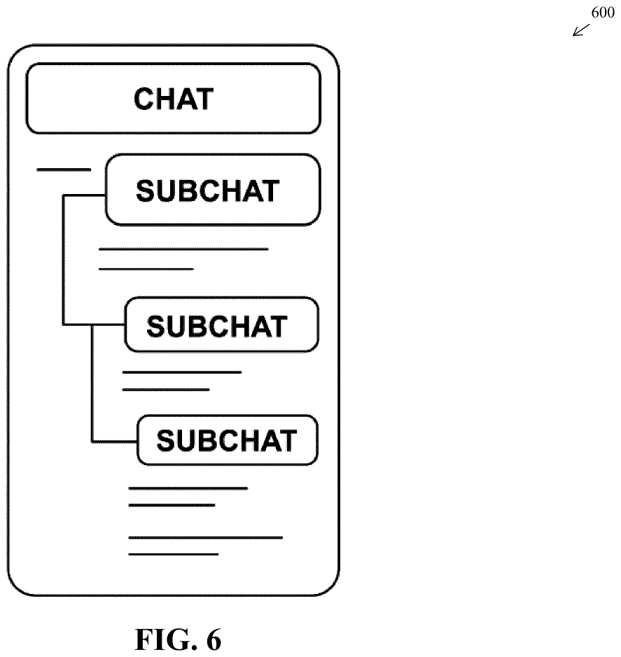

FIG. 6 depicts an example engagement visualization (interface 600) referred to as VibeCheQ. Listener devices transmit reaction data, such as likes, emoji responses, and comment frequency, to the control server, which aggregates the information into a composite engagement score. The resulting measure may be relayed back to all participants and displayed through dynamic indicators such as color changes, animated icons, or progress bars representing audience energy on the app itself. Various thresholds in terms of absolute values (e.g., intensity over/under a given threshold), or else in terms of rates of change (e.g., intensity rapidly increasing or decreasing), and so on may be used to translate this information into different levels of “VibeCheQ” indicators, such as hot/not, ok/good/great, etc. The visualization updates continuously during playback, allowing users to perceive collective enthusiasm in real time. This feedback loop encourages participation and offers hosts insight into audience response without interrupting the listening experience.

The disclosed system provides a comprehensive framework for real-time, socially connected music streaming that bridges the gap between isolated listening and live shared experiences. By combining synchronous playback with dynamic control-transfer models, the invention creates an environment where participants can interact, contribute, and influence the direction of a musical session in a structured yet flexible manner. The Open Aux mechanism introduces a round-robin scheduling method that ensures equal opportunity for contribution while maintaining uninterrupted playback. The Admin Aux and demAUXracy modes introduce governance and crowd-driven fairness, allowing session creators or listeners to determine control dynamically without disrupting the broadcast.

Unlike conventional collaborative playlists, the invention maintains a real-time broadcast stream that aligns playback across multiple devices using a common streaming source. This architecture eliminates timing inconsistencies while preserving the spontaneity of live listening. The inclusion of the Individual Pause feature maintains the cohesion of the group session while providing personalized control over playback, which is something lacking in typical broadcast systems.

The VibeCheQ subsystem further enhances engagement by transforming passive metrics into a living, visual representation of session energy, offering instant feedback that reflects listener sentiment. This not only improves user satisfaction but also fuels organic discovery, as highly active sessions naturally rise in prominence through visual cues and rankings. The integration of location-aware discovery allows users to connect with nearby sessions or communities, bridging digital and physical experiences.

From a technical standpoint, the invention efficiently leverages real-time communication protocols, dynamic queue management, and distributed streaming architecture to deliver low-latency synchronization and adaptive scalability. Collectively, these features establish a social listening framework that is richer, more interactive, and technically more robust than existing systems.

In some implementations, an illustrative method herein for synchronized social audio streaming among a plurality of user devices may comprise: receiving, at a control server, a request from a first user device to initiate a live audio broadcast session; creating, by the control server, a particular broadcast session in response to the request, including causing a streaming server to generate a corresponding streaming channel for the particular broadcast session; receiving, at the control server, a playlist of one or more audio tracks selected by a controlling device for the particular broadcast session as determined by broadcast control settings for the particular broadcast session; and instructing, by the control server, the streaming server to transmit audio data of a currently playing track of the playlist to a plurality of listener devices such that playback of the audio data occurs substantially synchronously across the plurality of listener devices.

In one embodiment, the control server further receives, from the controlling device, a selection of a particular audience visibility scope for the particular broadcast session, the particular audience visibility scope comprising one of a public audience, a friends-only audience, a followers-only audience, or a private invitation-based audience.

In one embodiment, the method further comprises: receiving, from the controlling device, a command to transfer broadcast control to a second user device participating in the particular broadcast session, wherein the control server authenticates the second user device and designates the second user device as the controlling device for subsequent audio transmissions.

In one embodiment, the method further comprises: receiving, from one or more requesting devices participating in the particular broadcast session, a request to transfer broadcast control to the one or more requesting devices; managing a voting process within the particular broadcast session among the plurality of listener devices regarding the request to determine a new controlling device from among the one or more requesting devices; and designating the new controlling device for subsequent audio transmissions according to an outcome of the voting process.

In one embodiment, each of the plurality of listener devices is a corresponding controlling device, the method further comprising: accepting additions to the playlist for subsequent audio transmissions based on one of either a first-come-basis or a round-robin basis from any of the plurality of listener devices.

In one embodiment, the controlling device is the first user device.

In one embodiment, the method further comprises: receiving, from one or more listener devices, engagement input data associated with the currently playing track, the engagement input data comprising at least one of comment text, emoji reaction, or hashtag tag; and storing the engagement input data in association with the particular broadcast session.

In one embodiment, the control server generates real-time engagement metrics for the particular broadcast session based on aggregated listener interactions, and causes visual indicators of the real-time engagement metrics to be displayed at the controlling device and the plurality of listener devices.

In one embodiment, the method further comprises: presenting a list of current broadcast sessions to a plurality of user devices.

In one embodiment, the method further comprises: managing user commentary from the plurality of listener devices within a commentary portion of an associated social audio streaming application on the plurality of listener devices.

In one embodiment, the corresponding streaming channel is accessible through a corresponding uniform resource locator (URL) accessed by an associated social audio streaming application on the plurality of listener devices.

Note that an illustrative flowchart outlining a procedure (method) in accordance with the method steps described above is effectively contemplated herein, accordingly.

In still other implementations, an illustrative apparatus herein may comprise: one or more network interfaces to communicate with a network; a processor coupled to the one or more network interfaces and configured to execute one or more processes; and a memory configured to store a process that is executable by the processor, the process comprising: receiving a request from a first user device to initiate a live audio broadcast session; creating a particular broadcast session in response to the request, including causing a streaming server to generate a corresponding streaming channel for the particular broadcast session; receiving a playlist of one or more audio tracks selected by a controlling device for the particular broadcast session as determined by broadcast control settings for the particular broadcast session; and instructing the streaming server to transmit audio data of a currently playing track of the playlist to a plurality of listener devices such that playback of the audio data occurs substantially synchronously across the plurality of listener devices.

In still other implementations, a tangible, non-transitory computer-readable medium may store computer-executable instructions that, when executed by one or more processors, cause a device to perform operations comprising: receiving a request from a first user device to initiate a live audio broadcast session; creating a particular broadcast session in response to the request, including causing a streaming server to generate a corresponding streaming channel for the particular broadcast session; receiving a playlist of one or more audio tracks selected by a controlling device for the particular broadcast session as determined by broadcast control settings for the particular broadcast session; and instructing the streaming server to transmit audio data of a currently playing track of the playlist to a plurality of listener devices such that playback of the audio data occurs substantially synchronously across the plurality of listener devices.

### Hierarchical Live Commenting With Focused Sub-Chats and Shareable Pivots

Existing live chat and commenting systems in social media and streaming applications typically present user comments in a flat chronological list or at best in a two-level thread (comment and reply). As discussion density increases, particularly in live music sessions or broadcast environments, these interfaces quickly become cluttered, forcing users to sift through unrelated threads to follow a single conversation. Conventional threading structures do not scale effectively for multi-topic, real-time discussions because they lack hierarchical organization, contextual filtering, or dynamic navigation between conversation layers.

In the context of synchronized audio streaming, where hundreds of users may react simultaneously to the same moment in a song, existing models cannot support branching discourse without overwhelming the interface. Users who wish to focus on a specific comment chain, such as a lyric interpretation, a production detail, or an artist's backstory, must manually scroll or search for related replies, leading to fragmented conversation flow. There remains a need for a hierarchical, dynamically scoped commenting system that allows real-time conversation threads to expand or collapse contextually, enabling participants to navigate, isolate, and share focused discussion branches within a live social streaming experience.

In one embodiment, therefore, the disclosed system provides a hierarchical commenting framework that enables real-time, multi-level discussion threads within a live streaming environment. Each user comment posted within a broadcast session or SynQ Space is assigned a unique comment identifier, and any reply to that comment inherits a parent-child relationship in a structured comment tree maintained by the control server. This hierarchical data model allows multiple nested conversation layers to exist under a single root thread while preserving the temporal order of comments at each level.

When displayed in the client interface, comments are presented within a single integrated pane capable of dynamic scoping. The user may choose to view the entire comment tree or focus on a specific branch by selecting a node in the hierarchy. Upon selection, the system “scopes in” to that branch, reconfiguring the visible comment stream so that only comments within the chosen thread are displayed in the main comment feed. The root of that thread becomes the focus node, and its parent nodes are compressed into a compact header (e.g., “In reply to [parent comment]—20 replies collapsed”), preserving context while minimizing clutter. Replies at deeper levels expand dynamically beneath the active thread as new comments arrive, maintaining chronological integrity within that branch only.

For example, within a live session where users discuss a song, a root comment might read, “What do these lyrics mean?” Replies such as “It's about a breakup” and “Yeah, they split last year” form the first sub-thread. A reply to “I didn't like her boyfriend anyway” might spawn a secondary thread, leading to “What did he do?” and subsequent replies forming another hierarchical layer. Each such layer is navigable via upward and downward traversal controls, allowing the user to move back up to the lyric discussion or deeper into the “boyfriend” discussion without leaving the live environment. The system visually distinguishes thread levels through indentation, shading, or collapsible indicators, ensuring that conversation depth remains intuitive and readable.

To support shareability, each thread or sub-thread can be addressed by a unique shareable pointer or hyperlink, allowing a user to invite others directly into that conversation branch. When another user follows the link, the application opens the broadcast or space context and automatically scopes to the referenced comment thread, presenting that conversation as the active feed. This allows users to isolate and continue discussions asynchronously while retaining their association with the original live session.

The underlying implementation relies on a real-time messaging subsystem integrated with the application control server. Each new comment or reply is transmitted as a lightweight message packet containing identifiers for session, parent comment, user, timestamp, and content. The control server appends this data to the hierarchical comment structure stored in a database, which may employ a parent-ID indexing model or adjacency list schema optimized for hierarchical retrieval. When a client scopes into a thread, the application retrieves only the subset of comments corresponding to the selected branch, thereby reducing bandwidth and rendering overhead while maintaining real-time synchronization for that thread.

The system also supports comment visibility synchronization such that users focused on different threads see independent but consistent live updates. For instance, two users may be scoped into separate sub-threads; each receives live comment updates relevant to their thread without being overwhelmed by unrelated conversation traffic. However, both threads remain connected to the same broadcast session, ensuring that comment timing aligns with the music or content being played. This architecture allows for rich, multi-topic engagement in a unified session without sacrificing usability or real-time responsiveness.

Said differently, in traditional social media and streaming platforms, live comment sections often become chaotic, with linear comment streams that can be challenging to follow, especially during high-activity events. As a result, meaningful conversations are often lost within the clutter, and users have little control over structuring their interactions. The Hierarchical Comments/Chats feature addresses these limitations by providing a multi-level commenting system within SynQ Spaces, where conversations can be organized, segmented, and accessed more easily. This feature introduces a more structured approach to social interaction within music streaming, allowing users to participate in organized live discussions, create private chats, and engage in thematic spaces that cater to specific topics or events.

The Hierarchical Comments/Chats feature in SynQ Spaces offers users an innovative way to engage in layered conversations during live music streams. Unlike standard comment systems, where all comments appear in a single, linear feed, this multi-level commenting system organizes discussions in tiers. Users can view popular conversations and choose to participate in the most active threads or explore new ones. By structuring comments hierarchically, this feature ensures that important conversations remain accessible, while enabling in-depth discussions to unfold in response to specific posts or events in the SynQ Space.

One of the core components of Hierarchical Comments/Chats is the ability to create private chat groups within a SynQ Space. For example, if a well-known artist, such as Taylor Swift, is SynQing out a session, fans could join the broadcast and set up private side chats with their friends, allowing them to interact on a smaller scale while tuning into the same event. This feature preserves the intimacy of a friend group while maintaining engagement with the larger broadcast, giving users more options for personalized communication.

Additionally, this feature includes a SynQ Thread Space, which allows users to create themed spaces with ongoing discussions, appointed moderators, multiple simultaneous SynQ Out broadcasts, and an archive of SynQ Out sessions. These themed spaces function as mini-communities where users can convene around a shared interest, such as a particular genre, artist, or event. Each SynQ Thread Space can support hierarchical commenting, letting users expand or collapse threads based on activity and relevance, similar to the tiered structure seen on traditional forums.

Users also have the option to filter comments in real time, viewing either the most recent comments or the most popular discussions, providing an organized and accessible view of live commentary. The tiered structure allows for a more nuanced conversation experience, where comments and replies can build upon each other, creating a meaningful and cohesive discussion even during busy SynQ Out sessions.

Advantageously, the Hierarchical Comments/Chats feature introduces a more organized and structured form of engagement in live music streaming. By categorizing comments into tiers, users can engage in deeper, more meaningful conversations that are easier to follow, even during high-activity broadcasts. The private chat capability provides flexibility, allowing users to maintain intimate conversations while still participating in larger, community-wide discussions. SynQ Thread Spaces enhance the social experience further, establishing dedicated, themed spaces for like-minded individuals, where conversations can continue long after a broadcast ends. Together, these features foster a sense of community, creating an interactive platform that combines the immediacy of live streaming with the structured interaction of traditional forums.

FIG. 6 shows a hierarchical comment model 600 that organizes real-time discussions into multiple nested layers. The main chat pane displays top-level messages associated with a broadcast. Selecting a particular comment opens a secondary subchat focused on that topic, while further replies may generate additional layers forming a structured tree. Arrows between columns may illustrate the parent-child relationship among messages. This organization allows users to follow specific threads of conversation without losing context of the broader discussion. The structure is maintained by the control server, which associates each message with a unique thread identifier and manages update propagation across all connected clients.

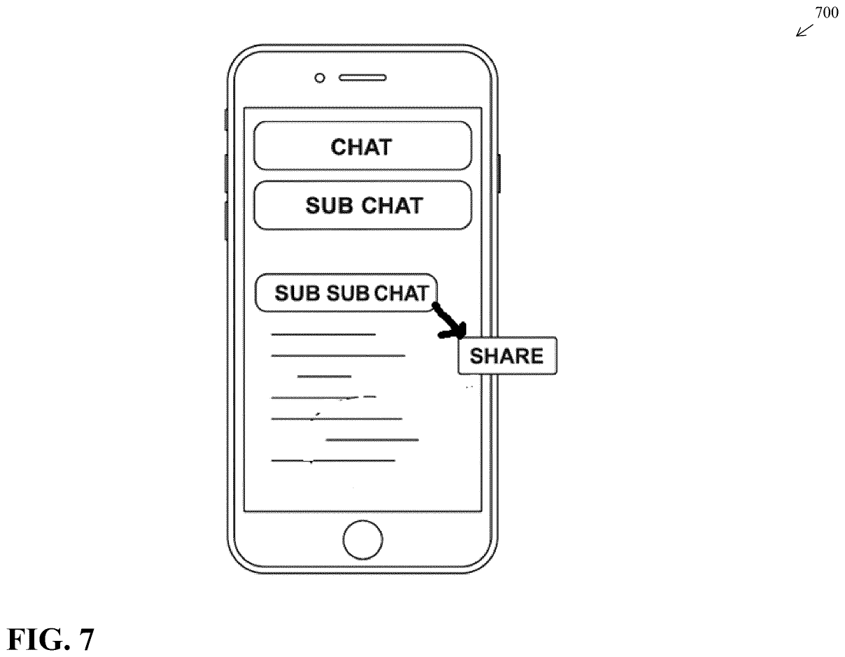

FIG. 7 illustrates an example 700 of how a participant can isolate and share a specific discussion branch within the hierarchical comment system. When a user selects a comment node, it may compress all other parent (and grandparent) chats, and hide any other branches of chats/threads not below the selected node. The application may also display options to “view thread” or “share thread.” Choosing to share generates a unique link pointing directly to that sub-conversation. Recipients who open the link are automatically presented with the corresponding subset of comments, scoped to that discussion while preserving live update functionality. The figure demonstrates how this mechanism supports asynchronous participation and targeted engagement, allowing conversations to be revisited or extended beyond the original session.

The hierarchical commenting system described herein introduces a novel architecture for real-time social interaction that enables structured, focused dialogue within live audio or broadcast environments. By organizing comments into dynamically scoped hierarchical threads, the invention eliminates the clutter and disorientation common to flat comment lists, allowing users to participate in or observe discussions relevant only to their interests. This improves both cognitive clarity and user satisfaction during high-volume engagement periods.

Unlike conventional threading models limited to a single reply layer, the disclosed system supports unlimited sub-threading depth while maintaining real-time synchronization across all comment levels. This enables a natural evolution of conversation (where topics branch organically and can be navigated intuitively) without sacrificing performance or continuity. The scoped view interface allows users to “zoom in” or “zoom out” between conversation layers seamlessly, reducing noise and fostering richer, more contextual exchanges.

The system also achieves significant technical efficiency by limiting data transmission and rendering to only the currently scoped comment set. Rather than continuously streaming every new comment across an entire live feed, the client device subscribes only to relevant hierarchical branches, dramatically lowering both bandwidth consumption and processing load during high-traffic sessions.

Further, the introduction of shareable pivots transforms static comment chains into portable, linkable discussion contexts. Users can re-engage specific conversations or invite new participants directly into a focused sub-thread without needing to scroll or search through the full comment history. This functionality encourages continuity of discussion beyond the initial broadcast, extending the lifespan and reach of user interactions.

From a social standpoint, the invention enriches engagement by enabling simultaneous yet non-interfering conversations within a single session. Multiple groups can converse about distinct aspects of the same content (e.g., lyrics, performance, production, or tangents/gossip) without cross-thread noise. Combined with real-time synchronization to the broadcast timeline, the system ensures that every conversation remains temporally aligned with the shared listening experience, promoting cohesion even in a distributed audience.

Collectively, these advantages deliver a technically elegant and socially intuitive commenting framework that elevates live streaming interaction into a structured, navigable, and shareable conversational experience.

In some implementations, an illustrative method herein for hierarchical real-time commenting within a live media broadcast environment may comprise: receiving, at a control server, a plurality of comment submissions from user devices participating in a broadcast session, each comment submission comprising a session identifier, a parent comment identifier, a user identifier, a timestamp, and comment content; storing, by the control server, the plurality of comment submissions in a hierarchical comment structure that defines parent-child relationships among comments based on the parent comment identifier; receiving, from a first user device, an input of a selection of a selected focus node of the hierarchical comment structure; transmitting, by the control server to the first user device, a subset of comments corresponding to a first branch of the hierarchical comment structure, the first branch being defined by the selected focus node and all corresponding descendant comments, causing display, by the first user device, only the subset of comments corresponding to the first branch within a comment pane of an application interface of the first user device; receiving, from the first user device, an updated input to navigate upward or downward within the hierarchical comment structure to a new focus node in the hierarchical comment structure; in response to the updated input, dynamically updating the subset of comments as displayed to reflect the new focus node in the hierarchical comment structure; and maintaining real-time synchronization of comment updates within a correspondingly displayed subset for a selected branch of the hierarchical comment structure while suppressing comment updates outside of the selected branch.

In one embodiment, each comment submission is transmitted as a lightweight message packet through a real-time messaging channel comprising at least one of: WebSocket, HTTP/2 stream, or publish-subscribe protocol.

In one embodiment, the method further comprises: generating, for each comment and sub-comment, a unique shareable link referencing a corresponding comment identifier and session identifier, the unique shareable link enabling remote users to open the broadcast session and automatically scope to an associated referenced comment branch.

In one embodiment, the application interface compresses ancestor comments above the selected focus node into a compact header.

In one embodiment, the hierarchical comment structure is stored using an adjacency-list schema or parent-ID index optimized for retrieval of nested comment sets.

In one embodiment, the method further comprises: dynamically subscribing the first user device only to message topics corresponding to the selected branch to reduce bandwidth consumption.

In one embodiment, new comments added within the selected branch are rendered in chronological order relative to existing comments, and comments outside the selected branch are queued but not displayed until the first user device navigates to that branch.

In one embodiment, navigation between hierarchical layers includes animated transitions or indentation indicators that visually represent conversation depth.

In one embodiment, the control server maintains independent synchronization states for multiple user devices scoped to different branches of the hierarchical comment structure, each state updating in real time for comments within its respective branch.

In one embodiment, the method further comprises: archiving the hierarchical comment structure with depth and timestamp metadata for replay or analysis synchronized to a timeline of the broadcast session.

Note that an illustrative flowchart outlining a procedure (method) in accordance with the method steps described above is effectively contemplated herein, accordingly.

In still other implementations, an illustrative apparatus herein may comprise: one or more network interfaces to communicate with a network; a processor coupled to the one or more network interfaces and configured to execute one or more processes; and a memory configured to store a process that is executable by the processor, the process comprising: receiving a plurality of comment submissions from user devices participating in a broadcast session, each comment submission comprising a session identifier, a parent comment identifier, a user identifier, a timestamp, and comment content; storing the plurality of comment submissions in a hierarchical comment structure that defines parent-child relationships among comments based on the parent comment identifier; receiving, from a first user device, an input of a selection of a selected focus node of the hierarchical comment structure; transmitting, to the first user device, a subset of comments corresponding to a first branch of the hierarchical comment structure, the first branch being defined by the selected focus node and all corresponding descendant comments, causing display, by the first user device, only the subset of comments corresponding to the first branch within a comment pane of an application interface of the first user device; receiving, from the first user device, an updated input to navigate upward or downward within the hierarchical comment structure to a new focus node in the hierarchical comment structure; in response to the updated input, dynamically updating the subset of comments as displayed to reflect the new focus node in the hierarchical comment structure; and maintaining real-time synchronization of comment updates within a correspondingly displayed subset for a selected branch of the hierarchical comment structure while suppressing comment updates outside of the selected branch.

In still other implementations, a tangible, non-transitory computer-readable medium may store computer-executable instructions that, when executed by one or more processors, cause a device to perform operations comprising: receiving a plurality of comment submissions from user devices participating in a broadcast session, each comment submission comprising a session identifier, a parent comment identifier, a user identifier, a timestamp, and comment content; storing the plurality of comment submissions in a hierarchical comment structure that defines parent-child relationships among comments based on the parent comment identifier; receiving, from a first user device, an input of a selection of a selected focus node of the hierarchical comment structure; transmitting, to the first user device, a subset of comments corresponding to a first branch of the hierarchical comment structure, the first branch being defined by the selected focus node and all corresponding descendant comments, causing display, by the first user device, only the subset of comments corresponding to the first branch within a comment pane of an application interface of the first user device; receiving, from the first user device, an updated input to navigate upward or downward within the hierarchical comment structure to a new focus node in the hierarchical comment structure; in response to the updated input, dynamically updating the subset of comments as displayed to reflect the new focus node in the hierarchical comment structure; and maintaining real-time synchronization of comment updates within a correspondingly displayed subset for a selected branch of the hierarchical comment structure while suppressing comment updates outside of the selected branch.

Note that in an alternative embodiment, the local device (e.g., the first user device) may receive all relevant commentary, and may locally manage the compression and expansion of the hierarchical branches according to local user selection.

In closing, the features described above help to redefine the music streaming experience by integrating social elements, real-time interaction, and community-driven features. The new app distinguishes itself by prioritizing user engagement, collaboration, and personalized content curation, setting a new standard for music streaming platforms.

Illustratively, the techniques described herein may be performed by hardware, software, and/or firmware (e.g., an “apparatus”), such as in accordance with the media collaboration process, process 248 (e.g., a “method”), which may include computer-executable instructions executed by the processor(s) 220 to perform functions relating to the techniques described herein, e.g., in conjunction with corresponding processes of other devices in the computer network as described herein (e.g., on computing devices, servers, controllers, agents, etc.). In addition, the components herein may be implemented on a singular device or in a distributed manner, in which case the combination of executing devices can be viewed as their own singular “device” for purposes of executing the process (e.g., process 248).

While the embodiments described above are presented in the context of an audio synchronization and social streaming application, it will be understood that the inventive concepts disclosed herein are not limited to that particular use case. The systems, methods, and data structures described may be applied to any environment in which synchronized content delivery, social interaction, or distributed user engagement is desired. For example, the same synchronization, control, and engagement mechanisms may be adapted for video, film, podcast, or mixed-media broadcasts, including live event streaming and collaborative video-watching applications.

In certain embodiments, the described features may be implemented in alternative forms of social media platforms unrelated to music. These may include live gaming streams, group chat environments, or content-sharing applications where users co-view or co-listen to shared media. The queuing, voting, and playback control features may similarly extend to collaborative playlists of movies, short clips, educational materials, or user-generated content.

It should also be recognized that the particular architectural arrangements illustrated and described, including separate control and streaming servers, may alternatively be implemented on a unified platform or distributed cloud infrastructure. Various embodiments may incorporate local caching, edge computing, or federated deployment without departing from the scope of the invention.

The specific embodiments, examples, and user interface depictions set forth herein are therefore to be regarded as illustrative rather than limiting. Variations in implementation, data handling, and presentation may be made by one of ordinary skill in the art without departing from the spirit or scope of the invention as defined by the appended claims. Unless expressly stated otherwise, no particular embodiment, component, or configuration described above should be construed as required or exclusive to the claimed invention.

That is, the foregoing description has been directed to specific embodiments. It may be apparent, however, that other variations and modifications may be made to the described embodiments, with the attainment of some or all of their advantages. Accordingly, this description is to be taken only by way of example and not to otherwise limit the scope of the embodiments herein. Therefore, it is the object of the appended claims to cover all such variations and modifications as come within the true intent and scope of the embodiments herein.

What is claimed is:

1. A method for hierarchical real-time commenting within a live media broadcast environment, comprising:
receiving, at a control server, a plurality of comment submissions from user devices participating in a broadcast session, each comment submission comprising a session identifier, a parent comment identifier, a user identifier, a timestamp, and comment content;
storing, by the control server, the plurality of comment submissions in a hierarchical comment structure that defines parent-child relationships among comments based on the parent comment identifier;
receiving, from a first user device, an input of a selection of a selected focus node of the hierarchical comment structure;
transmitting, by the control server to the first user device, a subset of comments corresponding to a first branch of the hierarchical comment structure, the first branch being defined by the selected focus node and all corresponding descendant comments, causing display, by the first user device, only the subset of comments corresponding to the first branch within a comment pane of an application interface of the first user device;
receiving, from the first user device, an updated input to navigate upward or downward within the hierarchical comment structure to a new focus node in the hierarchical comment structure;
in response to the updated input, dynamically updating the subset of comments as displayed to reflect the new focus node in the hierarchical comment structure; and
maintaining real-time synchronization of comment updates within a correspondingly displayed subset for a selected branch of the hierarchical comment structure while suppressing comment updates outside of the selected branch.

2. The method of claim 1, wherein each comment submission is transmitted as a lightweight message packet through a real-time messaging channel comprising at least one of: WebSocket, HTTP/2 stream, or publish-subscribe protocol.

3. The method of claim 1, further comprising:
generating, for each comment and sub-comment, a unique shareable link referencing a corresponding comment identifier and session identifier, the unique shareable link enabling remote users to open the broadcast session and automatically scope to an associated referenced comment branch.

4. The method of claim 1, wherein the application interface compresses ancestor comments above the selected focus node into a compact header.

5. The method of claim 1, wherein the hierarchical comment structure is stored using an adjacency-list schema or parent-ID index optimized for retrieval of nested comment sets.

6. The method of claim 1, further comprising:
dynamically subscribing the first user device only to message topics corresponding to the selected branch to reduce bandwidth consumption.

7. The method of claim 1, wherein new comments added within the selected branch are rendered in chronological order relative to existing comments, and comments outside the selected branch are queued but not displayed until the first user device navigates to that branch.

8. The method of claim 1, wherein navigation between hierarchical layers includes animated transitions or indentation indicators that visually represent conversation depth.

9. The method of claim 1, wherein the control server maintains independent synchronization states for multiple user devices scoped to different branches of the hierarchical comment structure, each state updating in real time for comments within its respective branch.

10. The method of claim 1, further comprising:
archiving the hierarchical comment structure with depth and timestamp metadata for replay or analysis synchronized to a timeline of the broadcast session.

11. An apparatus, comprising:
one or more network interfaces to communicate with a network;
a processor coupled to the one or more network interfaces and configured to execute one or more processes; and
a memory configured to store a process that is executable by the processor, the process comprising:
receiving a plurality of comment submissions from user devices participating in a broadcast session, each comment submission comprising a session identifier, a parent comment identifier, a user identifier, a timestamp, and comment content;
storing the plurality of comment submissions in a hierarchical comment structure that defines parent-child relationships among comments based on the parent comment identifier;
receiving, from a first user device, an input of a selection of a selected focus node of the hierarchical comment structure;
transmitting, to the first user device, a subset of comments corresponding to a first branch of the hierarchical comment structure, the first branch being defined by the selected focus node and all corresponding descendant comments, causing display, by the first user device, only the subset of comments corresponding to the first branch within a comment pane of an application interface of the first user device;
receiving, from the first user device, an updated input to navigate upward or downward within the hierarchical comment structure to a new focus node in the hierarchical comment structure;
in response to the updated input, dynamically updating the subset of comments as displayed to reflect the new focus node in the hierarchical comment structure; and
maintaining real-time synchronization of comment updates within a correspondingly displayed subset for a selected branch of the hierarchical comment structure while suppressing comment updates outside of the selected branch.

12. The apparatus of claim 11, wherein each comment submission is transmitted as a lightweight message packet through a real-time messaging channel comprising at least one of: WebSocket, HTTP/2 stream, or publish-subscribe protocol.

13. The apparatus of claim 11, wherein the process further comprises:
generating, for each comment and sub-comment, a unique shareable link referencing a corresponding comment identifier and session identifier, the unique shareable link enabling remote users to open the broadcast session and automatically scope to an associated referenced comment branch.

14. The apparatus of claim 11, wherein the application interface compresses ancestor comments above the selected focus node into a compact header.

15. The apparatus of claim 11, wherein the hierarchical comment structure is stored using an adjacency-list schema or parent-ID index optimized for retrieval of nested comment sets.

16. The apparatus of claim 11, wherein the process further comprises:
dynamically subscribing the first user device only to message topics corresponding to the selected branch to reduce bandwidth consumption.

17. The apparatus of claim 11, wherein new comments added within the selected branch are rendered in chronological order relative to existing comments, and comments outside the selected branch are queued but not displayed until the first user device navigates to that branch.

18. The apparatus of claim 11, wherein navigation between hierarchical layers includes animated transitions or indentation indicators that visually represent conversation depth.

19. The apparatus of claim 11, wherein the process maintains independent synchronization states for multiple user devices scoped to different branches of the hierarchical comment structure, each state updating in real time for comments within its respective branch.

20. A tangible, non-transitory computer-readable medium storing computer-executable instructions that, when executed by one or more processors, cause a device to perform operations comprising:
receiving a plurality of comment submissions from user devices participating in a broadcast session, each comment submission comprising a session identifier, a parent comment identifier, a user identifier, a timestamp, and comment content;
storing the plurality of comment submissions in a hierarchical comment structure that defines parent-child relationships among comments based on the parent comment identifier;
receiving, from a first user device, an input of a selection of a selected focus node of the hierarchical comment structure;
transmitting, to the first user device, a subset of comments corresponding to a first branch of the hierarchical comment structure, the first branch being defined by the selected focus node and all corresponding descendant comments, causing display, by the first user device, only the subset of comments corresponding to the first branch within a comment pane of an application interface of the first user device;
receiving, from the first user device, an updated input to navigate upward or downward within the hierarchical comment structure to a new focus node in the hierarchical comment structure;
in response to the updated input, dynamically updating the subset of comments as displayed to reflect the new focus node in the hierarchical comment structure; and
maintaining real-time synchronization of comment updates within a correspondingly displayed subset for a selected branch of the hierarchical comment structure while suppressing comment updates outside of the selected branch.
